(19) United States
(12) Patent Application Publication
(10) Pub. No.: US 2003/0048005 A1
(43) Pub. Date: Mar. 13, 2003

(54) Advanced power distribution system

(76) Inventors: Andrew B. Goldin, Temecula, CA (US); Hassan Yarpezeshkan, La Jolla, CA (US); David J. Fleming, Cardiff, CA (US)

Correspondence Address: N. THANE BAUZ, Fish & Richardson P.C., Suite 500, 4350 La Jolla Village Drive, San Diego, CA, 92122, US

(21) Appl. No.: 10/005,059

(22) Filed: Dec. 3, 2001

Related U.S. Application Data
(63) Continuation-in-part of application No. 09/955,405, filed on Sep. 12, 2001.

(51) Int. Cl. H02J 7/00

(52) U.S. Cl. 307/64

(57) ABSTRACT

A system and method for providing power to critical from a plurality of sources. The system provides a means of eliminating harmonics generated by loads from being conducted into the power source(s). Additionally, the system provides power conditioning to sags, surges and spikes produced by incoming sources. Power quality and system status monitoring and control are provided via communication mean such as the Internet.

### CROSS-REFERENCE TO RELATED APPLICATIONS

This application is a continuation-in-part application of, and claims priority to, U.S. application Ser. No. 09/955,405, filed on Sep. 12, 2001.

### TECHNICAL FIELD

This invention relates to a system for improving power quality and distribution, and more particularly to a power quality system including a harmonic cancellation unit.

### BACKGROUND

Modem electronic systems present conflicting requirements to power providers and the distributions systems they serve. On the one hand, many of the computer and telecommunication systems being brought on-line today present non-linear loads to the source that serves them. These non-linear loads reduce the quality of power locally and else where on the grid. Additionally, the non-linear loads result in wasted power and increased wiring requirements. On the other hand, many of these same loads are intolerant of the very quality problems that they create. Therefore there is a need for systems that reduce the disturbances created by the load while simultaneously improving the power to such loads.

One of the most common nonlinear loads is the input of a DC/DC converter on a personal computer or a telecommunications power supply. Typically composed of an input rectifier followed by smoothing capacitor, these systems draw current from the source at the peaks of the input voltage waveform. The result is a current waveform with a significantly higher RMS value than a linear load drawing the same power. This higher current in turn drives power systems to be designed with larger generation and distribution capacity.

Additional issues that arise due to non-linear loads are distortion of the voltage waveform on the power grid at locations close to such loads. Because power grids are not designed to accommodate the large number of non-linear loads that are on-line today, the system impedance causes voltage drops at the extremities of the power grid.

Systems to accomplish these goals are seen in U.S. Pat. Nos. 5,343,080 and 5,434,455. These systems describe two (or more) secondary windings on the transformer to accomplish the cancellation of harmonics. The secondary windings must, to some extent, share the load. This places a significant burden on system maintenance. When loads are removed the system must be rebalanced to provide the appropriate harmonic cancellation attribute.

Similarly, such systems must be tuned to address specific load generated harmonics. This consists of physically changing the output connections of the transformer. In addition to the setup time required to implement such a system, this same problem presents itself when loads are removed or replaced by others with different characteristics.

The filters that are part of the above referenced patent also do not address the issue of harmonic currents in the neutral connection. Harmonic currents, which can significantly exceed the phase currents, are by-products of nonlinear loads. Harmonic currents in the neutral connection significantly increase the cost of system wiring. For example, for three-phase power, the wiring may be increased, as much as twice in diameter, to accommodate an unbalanced load. In older buildings that were not designed for modern power requirements, heating problems in existing neutral connections can present safety issues, like fire as a result of the fact that unbalanced loads for three-phase power can significantly increase neutral currents and resistance heating.

### SUMMARY

The present invention addresses the shortcomings of present day power systems with a harmonic cancellation transformer having a filter, transfer switch, disconnection devices and surge suppression devices. These components can be combined in various ways to form systems that protect the critical load from a range of power quality events, e.g., from black outs to surges due to lightning. Additionally, these components combine to present a load to the power source that has significantly reduced levels of harmonic distortion.

The harmonic cancellation transformer includes a single secondary winding that can be wound to cancel the third and triplen harmonics of the excitation frequency. These harmonics represent a significant component of harmonic distortion in most systems. The transformer attenuates these harmonics in the primary and therefore on the power grid. When triplen harmonics are cancelled, the power grid is advantageously cleaner.

The filter in the secondary of the transformer can serve several functions. First, harmonics that may be present in the secondary circuit are attenuated—this can include all harmonics, not just the triplen harmonics. Second, the filter attenuates these harmonics in the secondary circuit thereby mitigating their deleterious affects and reducing the amount of wiring necessary, for example, in the neutral connections. Coupled with the single secondary form of the harmonic transformer, the system requires only one filter element. Typically downstream of filter, the transient suppression components provide protection to the load from over voltage events on the primary side.

In one embodiment of the invention, a harmonic cancellation unit is connected to a uninterrupted transfer switch (UTS). The transfer switch provides appreciably uninterrupted power from a plurality of sources. The UTS is setup to automatically switch from the presently utilized source to an alternate source in a time span short enough to be undetectable to sensitive loads. In this configuration, the harmonic cancellation unit further improves the power quality received by the load. Control and remote monitoring can be included to further improve system performance and flexibility.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 schematically depicts an Advanced Power Distribution System, according to the present invention.

FIG. 2 schematically depicts an Advanced Power Distribution System including an Uninterruptible Transfer Switch (“UTS”) and a Harmonic Cancellation Module.

FIG. 3 schematically depicts a Harmonic Cancellation Unit including a Zig-Zag transformer with common mode and differential mode passive filters for use in Power Distribution Systems.

FIG. 4 schematically depicts a Harmonic Cancellation Unit including a Delta-Wye transformer with common mode and differential mode passive filters for use in Power Distribution Systems.

### DETAILED DESCRIPTION

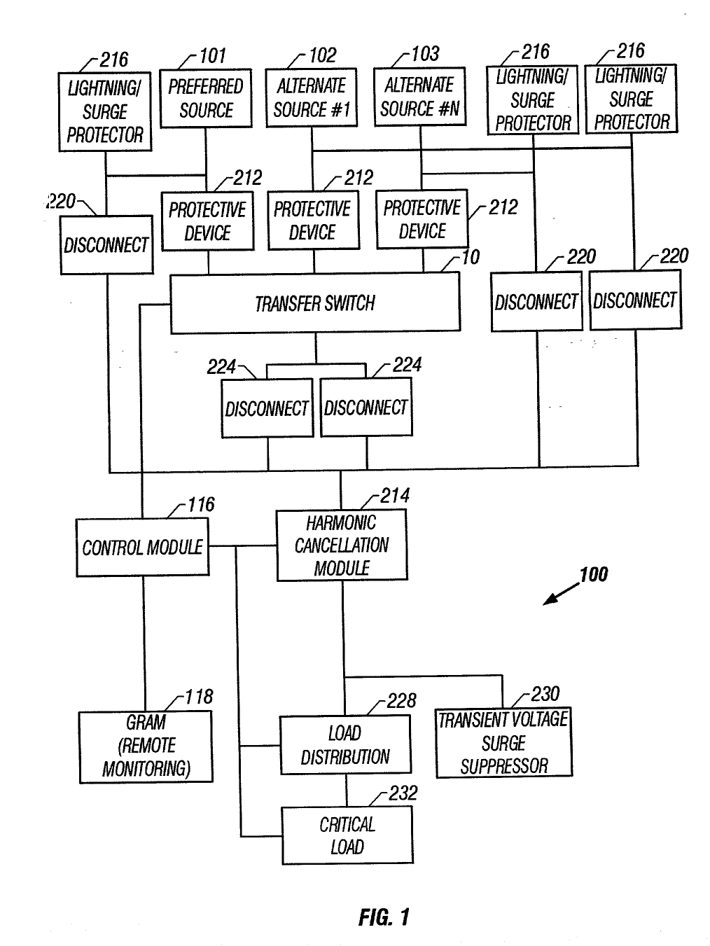

FIG. 1 illustrates an embodiment of an Advanced Power Distribution System 100 according to the present invention. The Advanced Power Distribution System 100 can include a primary 101 and alternate source(s) 102, protective devices 212, Harmonic Cancellation Module 214, Lightning/Surge protector 216, disconnects 218, 220, and 224, transfer switch 10, remote monitoring (GRAM) 118, control module 116, Transient Voltage Surge Suppressor (TVSS) 230, load distribution 228, and the critical load(s) 232.

Sources 101, 102 or 103 may include power from a utility company, or generated power from diesel generators, fuel cells, nuclear power plants, and other well known sources. This power is then fed into the transfer switch 10. The transfer switch 10 is used to transfer between any one of the sources. This allows power from the alternate source(s) to be switched to the critical load(s) 232 in the event the preferred source 101 exhibits a loss of power. The transfer switch 10 can be a SCR, Triac, IGBT, Relay, Contactor, an Uninterruptible Transfer Switch (UTS), or other well known transfer switch.

The output of the transfer switch 10 is connected to the primary of the Harmonic Cancellation Module 214 through disconnect device(s) 224. As described further below, the Harmonic Cancellation Module 214 attenuates harmonics in the Advanced Power System 100. This can be accomplished, for example, by use of a transformer and appropriate filters (not shown) as described further below. Protective devices 212 protect the system from harmful electrical failures, e.g., short circuit conditions caused by the critical loads 232, or by a transformer short, or from a failed transfer switch 10. Device(s) 212 and 224 could be circuit breaker(s), fuse(s), vacuum breaker(s) or other well known current limiting device(s).

Lightning/Surge Arrestor 216 is a device that shunts high energy/noise pulses into the grounding system of the building. For example, exemplary devices are capable of handling currents of 40 kA or greater. For example, Lightning/Surge Arrestor 216 can be Metal Oxide Varistors (MOV's), lightning arrestors, active clamping devices, or other well known clamping devices.

Disconnects 220 and 224 are used to provide a maintenance mechanism to allow power to be diverted around the transfer switch 10, for example, in the event of failure. Transient Voltage Surge Suppressor (TVSS) 230 is a device that shunts energy/noise pulses between line and neutral connected to the critical load 232. Typically, this device is capable of handling currents of 500 A or greater. These devices can include Metal Oxide Varistors (MOV's), lightning arrestors, active clamping devices, or other well known clamping devices.

Load distribution 228 allows a plurality of critical loads 232 to be connected to the system 100. The load distribution 228 allows single phase loads, dual phase loads, as well as three phase loads to be connected to system 100. This can be achieved, for example, by single molded case switches or circuit breakers or by combinations of 42 pole panels.

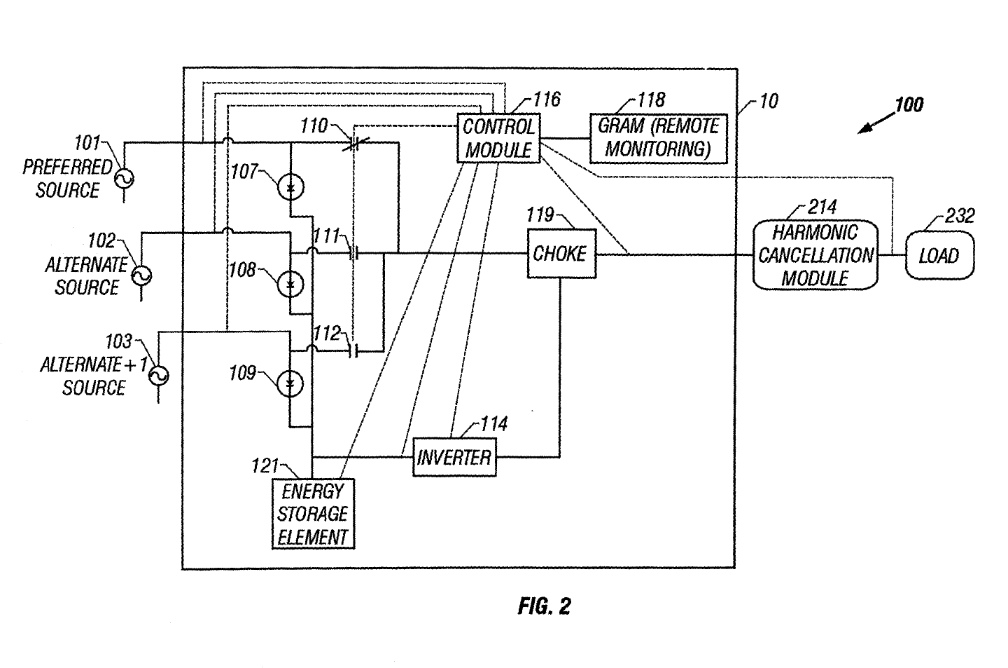

FIG. 2 depicts another embodiment of the Advanced Power Distribution System 100. While shown as single lines, the power sources 101, 102, 103 can be multi-phase or single-phase. Switches 110, 111, 112 isolate each of the power sources from the load 232. A source designated as the “preferred source” 101 is the power source that will be selected by the transfer switch 10 as long as the preferred source 101 meets certain predetermined power quality requirements such as amplitude, phase, and frequency stability. In this embodiment, the transfer switch 10 is an Uninterruptible Transfer Switch (“UTS”), which means that the load 232 will not experience an appreciable voltage outage during switching of the power sources. Protective devices and lightning/surge protectors (not shown) can be added between the power sources and the load 232 to protect the load 232 from transient events that may occur up-stream of the UTS 10.

A choke 119 is in-line with the load 232. The choke 119 is typically a passive, low loss, element that performs no significant function during normal operation of the UTS 10. The choke 0.119 can pass current from the selected source to the load. The choke 119 may be a standard choke or a coupled inductor. The choke can also be replaced with any of a variety of well-known transformers used in power applications, like isolation transformers.

Rectifiers 107, 108, and 109 are coupled to the source side of the switches 110, 111, 112. During normal operation, i.e., non-transient power conditions, any of the rectifiers 107, 108, 109 can feed an inverter 114 from any power source, typically one with the highest voltage. Because the inverter 114 can be controlled in the manner described below, in a low power, “stand-by” state, the current passed through the rectifiers can be minimal and therefore power dissipation is advantageously low. During stand-by operation, the inverter 114 can also be used to regulate voltage to the load 232 and used to improve power factor of the load 232. When the power sources are being switched, i.e., during transient conditions, the inverter 114 is used provide power to the load 232.

The inverter 114 input can include a bank of electrolytic capacitors (not shown) used in conjunction with the rectifiers to sufficiently “smooth” the input voltage to the inverter 114. During normal operation, the inverter 114 maintains a sinusoidal voltage at the output of filter 115 and the auto transformer 117 substantially equal in amplitude at the load 232. Therefore, the aggregate affect of the UTS 10 on system power during normal operation is minimal.

Referring again to FIG. 2, the system 100 can include the addition of energy storage element 121. Energy storage element 121 provides energy to the inverter independent of all sources. In this way, the energy storage element 121 enables the system to “ride-through” instances when none of the power sources are able to provide power to the load. In this way, the system can be configured so that the alternative power source need not be readily available, for example, an engine-driven generator or turbine. Thus, the energy storage element 121 can provide energy to the inverter while and until the alternative source is able to generate power. Energy storage element 121 can consist of any well-known components, e.g., generator, turbine, electro-chemical capacitors, double layer capacitors, battery, electrolytic capacitors, hybrid capacitor/battery, fuel cell, super capacitor, HED (high energy-density) capacitor, etc. For example, the battery can be any well known type like lead acid, lithium, NiCAD, NiMH, etc.

Control module 116 can control the operation of the system 100, including switches 110, 111, and 112. The control module 116 can sense power quality from the sources 101, 102, 103 as well as their respective power output quality, for instance, voltage, current, phase and frequency. For example, using DQ transformation as well as individual line-line criteria, the power quality of all of the input power sources can be monitored by control module 116.

Operators can program the control module 116 to operate elements of the UTS 10 and the Harmonic Cancellation Unit 214 in accordance with the requirements of the load 232. That is, such programs can be altered depending upon the system operational requirements of the load 232, for example, how sensitive the load 232 is to changes in power quality. When the power quality of the presently utilized source falls outside of user-determined bounds for a predetermined time period, the control module 116 can initiate the process of switching to another source. For that reason, the control module 116 is coupled to and can control actuation of switches 110, 111, and 112. Because the control module 116 can monitor all sources, an alternate source can be identified at all times. Software to facilitate the functions of control module 116 can reside in numerous places in system 100, including remote monitoring 118 and control module 116.

The control module 116 can also monitor power quality coming into the inverter 114. Likewise, the control module 116 can monitor power quality coming out of the inverter 114 (not shown). This may be particularly useful in controlling the operation of the inverter 114 so that power quality, like voltage, current, frequency and phase is monitored and maintained by controlling the operation of the inverter 114. The control module 116 can also activate, operate and deactivate the inverter 114. The control module 116 can also monitor and control the operation of the energy storage element 121.

The control module 116 can also monitor power quality input to the load 232. This will help the control module 116 to prevent undesirable power quality from reaching the load 232. Those of skill in the art will appreciate that the control module 116 can perform additional functions like maintenance and diagnostic functions of any or all system 100 elements. For example, the control module 116 can include memory functions to keep a history of the Advanced Power Distribution System 100 operation and the associated variables.

Referring again to FIG. 2, remote monitoring unit 118 can be coupled to any and all components of the system 100. During all modes of operation, the remote monitoring unit 118, also referred to as GRAM (Global Remote, Advanced Monitoring) provides the functions of remotely monitoring and/or controlling system 100, including UTS 10 and Harmonic Cancellation Module 214. Remote monitoring unit 118 can transmit and/or receive system 100 information concerning some or all of the system 100 state variables, for example, operating amplitudes, frequencies, integrity of system components, availability and selection of power sources, and power quality including, but not limited to input voltage, input current, input power (watts, VA, VARS), input voltage distortion, input current distortion, input THD, input Power Factor, input surge events, input brown outs, input black outs, output voltage, output current, output power (watts, VA, VARS), output voltage distortion, output current distortion, output THD, output Power Factor, output surge events, brown outs, black outs. GRAM 118 can also be utilized to control or change some or all of the system 100 state variables, including but not limited to UTS 10 and Harmonic Cancellation Module 214 state variables, like inverter 114 operation, source selection, harmonic frequency attenuation or excitation, etc. GRAM 118 can transmit and receive this information to external remote devices to allow control and monitoring of the system 100 using any well-known communication technology, e.g., satellite link, cellular link, telephone link, etc. Additionally, GRAM 118 can communicate to remote devices like laptop computers or similar devices, via several different communication protocols such as TCP/IP, MODBUS, etc.

For example, once the control module 116 has detected an out of specification condition in the preferred source 101, e.g., transient power condition, the control module can initiate steps directed to changing power sources without appreciable interruption in power supplied to the load 232. A signal from the control module 116 can trigger the inverter 114 to active mode. During the normal state, the inverter 114 can be in a standby mode passively synchronized to the power source.

Upon receipt of the command to control output voltage, for example from the control module 116, the inverter 114 draws power from the one or more of the rectifiers 107, 108, 109 and begins furnishing power to the load 232. Following activation of the inverter 114, the control module 116 can issue a command resulting in the opening of switch 110 thereby disconnecting the failing source 101 from the load 232. In a like manner, the control module 116 can monitor and control the operation of the Harmonic Cancellation Module 214 in order to provide power to load 232 in accordance with the invention. For example, the control module 116 can detect degraded power quality, for example by the presence of undesired harmonic frequencies or out of specification in neutral currents. Likewise, the control module 116 can actuate, for example, variable components in filters 364 and/or 366 to attenuate the unwanted harmonics thereby improving system 100 performance so that load 232 receives improved power quality.

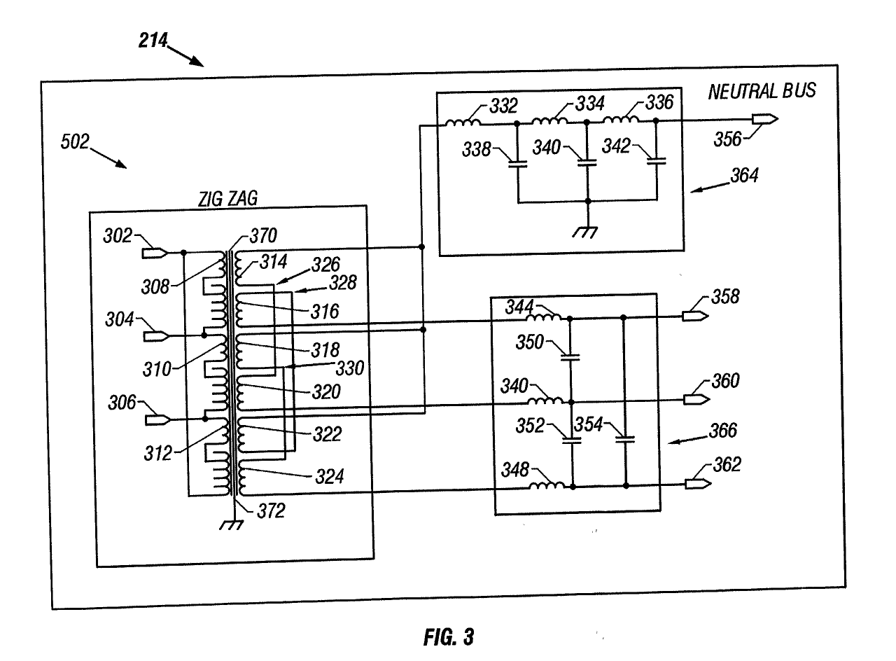

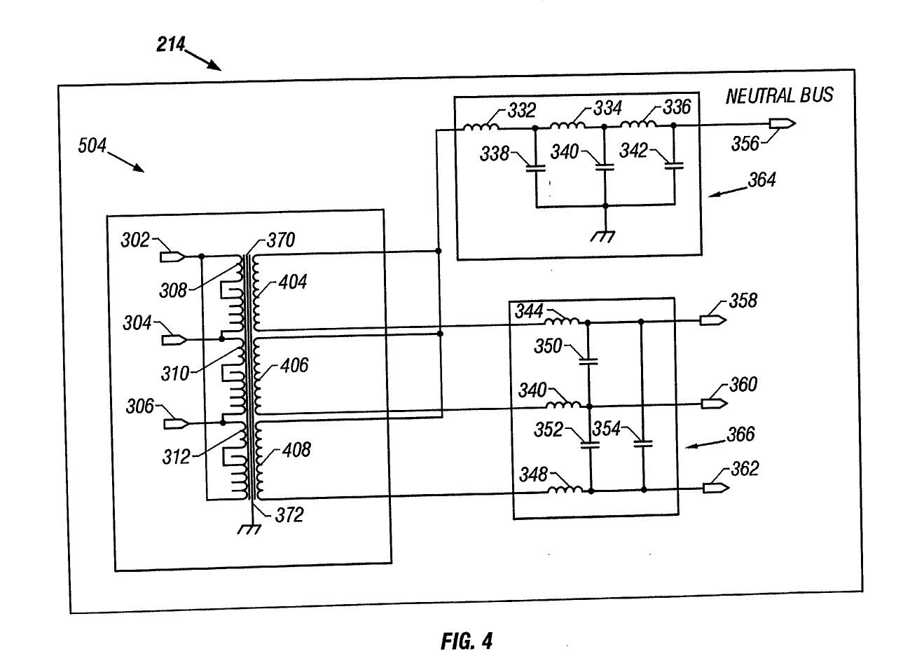

Embodiments of the Harmonic Cancellation Module 214 are depicted in FIG. 3 and FIG. 4. Physical construction of the transformer, core, coils, and filters are not shown as this is well understood by those skilled in the art. FIG. 3 describes the Harmonic Cancellation Module 214 that can attenuate triplen harmonics. Triplen harmonics are odd harmonics which are the odd multiples of the third harmonic, e.g., 3^{rd}, 9^{th}, 15^{t}, 21^{st}, etc. The Harmonic Cancellation Module 214 depicted in FIG. 3 also attenuates the 5^{th}, 7^{th}, 11^{th} harmonics. These harmonics are attenuated by the combination of the transformer 502, common mode filter 366, and differential mode filter 364.

The transformer 502 is constructed utilizing three phase primary input windings 308, 310, 312, configured in a Delta configuration, with multiple taps, and three phase output windings 314, 316, 318, 320, 322, 324 configured in an interconnected star (“Zig-Zag”) winding. The windings for both the primary and secondary windings can be constructed by any well known means, for example from copper, aluminum, wire or foil.

The windings are placed on a core structure 370 that can be made from steel, silicon steel, amorphous metal or other well known magnetic materials. Core structure 370 can be either a single structure, or three separate structures. The primary Delta configuration shown is wired by connecting one end of coil 308 to one end of coil 310, and one end of coil 310 to one end of coil 312, and finally by connecting one end of coil 312 to one end of coil 308 as depicted in FIG. 3. The three phase inputs 302, 304, 306 are connected to the primary windings 308, 310, 312 as shown in FIG. 3. The interconnected star winding (Secondary) is arranged in core structure 370 by phase shifting the secondary windings, allowing the triplen harmonics to be eliminated from being induced into the primary winding. The secondary winding is configured by sharing the individual phase windings in different legs of the core structure 370.

‘Phase A’ output of the transformer is connected as follows: Coil 314 is wound on the ‘Phase A’ leg of the core 370 and coil 320 is wound on the ‘Phase B’ leg of the core 370. One end of coil 314 is connected to one end of coil 320 at 326. The other end of 314 is connected to the neutral output of transformer 502, along with coil 318, and coil 322. The phase output of the transformer for ‘Phase A’ is connected from one end of coil 316 to one end of inductor 344.

‘Phase B’ output of the transformer is connected as follows: Coil 318 is wound on the ‘Phase B’ leg of the core 370 and coil 324 is wound on the ‘Phase C’ leg of the core 370. One end of coil 318 is connected to one end of coil 324 at 330. The other end of 318 is connected to the neutral output of transformer 502, along with coil 314, and coil 322. The phase output of the transformer for ‘Phase B’ is connected from one end of coil 320 to one end of inductor 340.

‘Phase C’ output of the transformer is connected as follows: Coil 322 is wound on the ‘Phase C’ leg of the core 370 and coil 316 is wound on the ‘Phase A’ leg of the core 370. One end of coil 322 is connected to one end of coil 316 at 328. The other end of 322 is connected to the neutral output of transformer 502, along with coil 314, and coil 318. The phase output of the transformer for ‘Phase C’ is connected from one end of coil 324 to one end of inductor 348.

The transformer 502 alone can only effectively cancel triplen harmonics as described earlier, and only with balanced loads. The Wye connected loads contribute a large percentage of 3^{rd} harmonics in which transformer 502 can cancel from the secondary to the primary windings. However, these harmonics, known as zero sequence harmonics, add up in the neutral conductor of the secondary circuit, and as such must be rated for at least 1.73 times the line current. These currents have been known to overheat transformers, as well as building wiring, and associated protective devices. With modem power systems, it is hard for the end user to ensure that the loads are connected to balance the output seen by the secondary winding of transformer 502, as these loads could be a plurality of single phase loads. In order to handle the imbalance of the three phase output, and to attenuate the harmonics in the neutral side of the loads, one embodiment of the invention includes a filter 364 as part of the Harmonic Cancellation Module 114.

The filter 364 effectively attenuates the 3^{rd} harmonic in the neutral line. However, it should be noted that the filter is capable of being tuned to this and other harmonics. As depicted in FIG. 3, the filter 364 is a three pole, L/C type, band reject filter. The 3^{rd} harmonic is attenuated by filter components, capacitors 338, 340, 342 and inductors 332, 334, 336. The values of these components can vary based on the design requirements, and available components. Typically, these values can be selected by determining the desired corner frequency calculated from the equation fc=(½π) Square Root(LC), where L is the inductance and C is the capacitance. The inductors 332, 334, 336 can be made of different core materials such as ferrite, iron, powdered iron, steel, silicon steel, amorphous metals, and other know materials. The inductors 332, 334, 336 could also be a single inductor, or a plurality of inductors to make the desired inductance. The capacitors 338, 340, 342 can be of different materials such as polyester, metalized polyester, polycarbonate, metalized polycarbonate, oil filled, paper, ceramic, mica, or other well known materials. The capacitors 338, 340, 342 could also be a single capacitor, or a plurality of capacitors to make the desired capacitance. The tuned filter diverts the unwanted harmonic neutral current into the ground conductor 372, thus attenuating unwanted harmonics, reducing the amount of the particular harmonics making the neutral current equal to or less than the line current.

Load 232 can predominantly generate the 5^{th}, 7^{th,} and 11^{th} harmonics. These harmonics do not return to the neutral, and are not treated by filter 364 or by transformer 502. In order to attenuate and treat these harmonics, filter 366 can be employed. Filter 366 can be designed to effectively attenuate harmonics greater than 250 Hz, and frequencies greater than 250 Hz are typically attenuated at 40 dB/decade. However, it should be noted that filter 366 is capable of being tuned to this and other frequencies. Filter 366 can be a L/C type, low pass filter as shown in FIG. 4. Components in the filter 366 attenuate harmonics. The components include capacitors 350, 352, 354 and inductors 344, 346, 348. As discussed above in relation to filter 364, the values of these components can vary based on the design requirements, and available components. Typically, these values can be selected by determining the desired corner frequency calculated from the equation fc=(½π) Square Root(LC), where L is the inductance and C is the capacitance. The inductors 344, 346, 348 can be made of different core materials such as ferrite, iron, powdered iron, steel, silicon steel, amorphous metals, and other know materials. The inductors 344, 346, 348 could also be a single inductor, or a plurality of inductors to make the desired inductance. The capacitors 350, 352, 354 can be of different materials such as polyester, metalized polyester, polycarbonate, metalized polycarbonate, oil filled, paper, ceramic, mica, or other well known materials. The capacitors 350, 352, 354 could also be a single capacitor, or a plurality of capacitors to make the desired capacitance. The tuned filter attenuates load generated harmonics from conducting into the secondary of transformer 502, thus attenuating these harmonics from being seen on the primary side of transformer 502.

Although filters 364 and 366 are depicted as passive elements, those of skill in the art will appreciate that these filters can employ active elements, e.g., microprocessor controlled adjustable filters. In this way, the filters 364 and 366 can be arranged to create adjustable filters that can have variable characteristics, like frequency cutoffs. This is advantageous in applications where unwanted harmonics and neutral currents vary and therefore filters 364 and 366 can be optimized “on the fly” to respond to transient conditions thereby optimizing power quality delivered to load 232. As described earlier, control module 116 and/or remote monitoring 118 can be utilized to adjust the Harmonic Cancellation Module 214.

FIG. 4 depicts another embodiment of the Harmonic Cancellation Module 214 which can attenuate harmonics as in FIG. 3, with an exception. Transformer 504 does not attenuate triplen harmonics. The construction of transformer 504 is similar to the construction of transformer 502 of FIG. 3 except for the connection of the secondary windings. ‘Phase A’ output of the transformer is connected as follows: Coil 304 is wound on the ‘Phase A’ leg of the core 370. One end of coil 404 is connected to the neutral output of transformer 504, along with coil 406, and coil 408. The phase output of the transformer for ‘Phase A’ is connected from one end of coil 404 to one end of inductor 344.

‘Phase B’ output of the transformer is connected as follows: Coil 406 is wound on the ‘Phase B’ leg of the core 370. One end of coil 406 is connected to the neutral output of transformer 504, along with coil 404, and coil 408. The phase output of the transformer for ‘Phase B’ is connected from one end of coil 406 to one end of inductor 340.

‘Phase C’ output of the transformer is connected as follows: Coil 408 is wound on the ‘Phase C’ leg of the core 370. One end of coil 408 is connected to the neutral output of transformer 504, along with coil 404, and coil 406. The phase output of the transformer for ‘Phase C’ is connected from one end of coil 408 to one end of inductor 348.

Referring again to FIG. 2, and as discussed above, control module 116 interrogates the system 100 for power quality including, but not limited to input voltage, input current, input power (watts, VA, VARS), input voltage distortion, input current distortion, input THD, input Power Factor, input surge events, input brown outs, input black outs, output voltage, output current, output power (watts, VA, VARS), output voltage distortion, output current distortion, output THD, output Power Factor, output surge events, brown outs, black outs. The control module 116 transmits this information to remote monitoring (GRAM) 118 so that system 100 can be remotely monitored and/or controlled. Additionally, as discussed above, software can be incorporated into both control module 116 and remote monitoring 118 so that the system automatically controls system 100 to compensate for any and all preprogrammed out of specification conditions. Likewise, remote monitoring 118 can be utilized to download upgraded software remotely, altered system 100 performance specification criteria remotely, or like information remotely thereby resulting in a more manageable and dynamic system 100.

The control module 116 and remote monitoring 118 can interrogate the system 100 to include but not limited to temperature conditions of transformers in Harmonic Cancellation Module 214, status of disconnects 220 and 224, status of protective device(s) 212, lightning surge protector 216, transfer switch 10, voltages and currents associated with load distribution 228, and status of transient voltage surge suppressor 230. The control module 116 and/or the remote monitoring 118 can include storage media to store data concerning the performance of system 100. As discussed above, the remote monitoring 118 can transmit the system 100 performance data via the internet, phones lines, fiber optic lines, wireless means, or by any well known communication media.

A number of embodiments of the invention have been described. Nevertheless, it will be understood that various modifications may be made without departing from the spirit and scope of the invention.

What is claimed is:

1. An advanced power distribution system including an uninterruptible transfer switch coupled to at least two power sources and a load comprising:
a first switch having a first and second end, said first end coupled to a first power source, said second end coupled to said load;
a second switch having a first and second end, said first end coupled to a second power source, said second end coupled to said load;
a control module coupled to said first and second switch, said control module capable of actuating said first and second switch in order to select said power sources received by said load;
an inverter for providing power to said load when said control module actuates said first and second switches;
a first rectifier, having a first and second end, said first end coupled to said first end of said first switch, said second end of said rectifier coupled to said inverter;
a second rectifier, having a first and second end, said first end coupled to said first end of said second switch, said second end of said second rectifier coupled to said inverter; and
a harmonic cancellation unit comprising a transformer and at least one filter for attenuating system harmonics.

2. An advanced power distribution system as recited in claim 1, further including a remote monitoring unit coupled to said control module for receiving and transmitting system information and allowing remote control of at least two of the advanced power distribution system state variables.

3. An advanced power distribution system as recited in claim 1 wherein said transformer windings have a zig-zag configuration with a single secondary winding.

4. An advanced power distribution system as recited in claim 1 wherein said transformer windings have a delta-wye configuration with a single secondary winding.

5. An advanced power distribution system as recited in claim 1 wherein said filter comprises a common mode filter connected to the neutral bus of said transformer and a differential filter connected to the secondary winding of said transformer.

6. An advanced power distribution system including an uninterruptible transfer switch coupled to at least two power sources and a load comprising:
a first switch having a first and second end, said first end coupled to a first power source, said second end coupled to said load;
a second switch having a first and second end, said first end coupled to a second power source, said second end coupled to said load;
A control module coupled to said first and second switch, said control module capable of actuating said first and second switch in order to select power sources received by said load;
an inverter for providing power to said load when said control module actuates said first and second switches;
a first rectifier, having a first and second end, said first end coupled to said first end of said first switch, said second end of said rectifier coupled to said inverter;
a second rectifier, having a first and second end, said first end coupled to said first end of said second switch, said second end of said second rectifier coupled to said inverter; and
a harmonic cancellation unit for attenuating harmonic frequencies.

7. The advanced power system recited in claim 6 further including surge suppressors coupled to said first ends of said first and second switch.

8. An advanced power system including an uninterruptible transfer switch coupled to a first power source, a second power source and a load comprising:
a first switch means for transferring power to said load, said first switch means having a first and second end, said first end coupled to a first power source, said second end coupled to said load;
a second switch means for transferring power to said load, said second switch means having a first and second end, said first end coupled to a second power source, said second end coupled to said load;
control means for actuating said first and second switch in order to select the power source received by said load, said control means coupled to said first and second switch;
inverter means for providing power to said load when said control means actuates said first and second switches in order to alternate power source received by said load;
an inductor means for electrically isolating said sources and inverter means during switching of power from one power source to another, said inductor means coupled to said load, said first and second switch, and said inverter;
a first rectifier means for providing power to said inverter means, said rectifier having a first and second end, said first end coupled to said first end of said first switch means, said second end of said rectifier coupled to said inverter means;
a second rectifier means for providing power to said inverter means, said rectifier having a first and second end, said first end coupled to said first end of said second switch means, said second end of said second rectifier coupled to said inverter means;
a harmonic cancellation means coupled to said uninterruptible transfer switch for attenuating harmonic frequencies.

9. A method of maintaining power quality in an advanced power distribution system while switching power sources from a primary power source to an alternative power source without appreciable power loss to the load comprising:
monitoring power quality of a preferred power source and an alternate power source;
determining from a predefined set of power quality variables that the power quality from the primary source has degraded to an unacceptable level;
opening all switches that route the primary power source to the load;
supplying power to the load from the inverter at the time that the primary power source is disconnected from the load so that no appreciable power loss occurs on the load;
slewing amplitude and phase of power provided by the inverter to the load so that it substantially matches the amplitude and phase of alternative power source;
closing the switch that routes power from the alternative power source to the load;
taking the inverter off line so that the load receives power from the alternative power source without appreciable power loss on the load; and
attenuating harmonic frequencies in a transformer and filter to improve power quality provided to said load.

10. A harmonic cancellation unit for attenuating harmonic frequencies in a power distribution system comprising:
a transformer having a single secondary winding;
a filter coupled to said neutral bus of said transformer for attenuating at least the 3^{rd} harmonic;
a filter coupled to said secondary winding of said transformer for attenuating
at least one odd harmonic greater than the 3^{rd} harmonic.
